(19) United States
(12) Patent Application Publication
(10) Pub. No.: US 2003/0059692 A1
(43) Pub. Date: Mar. 27, 2003

(54) Method of manufacturing a matrix for cathode-ray tube

(76) Inventors: Samuel Pearlman, Lancaster, PA (US); Robert Earl Kreider, Lancaster, PA (US); Richard LaPeruta JR., Lititz, PA (US)

Correspondence Address: THOMSON multimedia Licensing Inc., Patent Operations, Two Indepence Way, Post Office Box 5312, Princeton, NJ, 08540-5312, US

(21) Appl. No.: 09/962,520

(22) Filed: Sep. 25, 2001

(51) Int. Cl. H01J 9/20

(52) U.S. Cl. 430/25; 430/24; 430/26

(57) ABSTRACT

A method of manufacturing a luminescent screen assembly, having a light-absorbing matrix with a plurality of substantially equally-sized openings therein, on an inner surface of a faceplate panel of a cathode-ray tube (CRT) is provided. The tube has a color selection electrode spaced from the inner surface of the faceplate panel in which the color selection electrode has a plurality of strands interleaved with slots. The method includes the steps of providing a first photoresist layer, whose solubility is altered when exposed to light, such that greater dosages of light reduce the solubility thereof. The first photoresist layer is applied to the inner surface of the faceplate panel. The first photoresist layer is exposed to light from a light source, located relative to a central source position, as well as two symmetrical source positions relative to the central source position. The exposure selectively alters the solubility of the illuminated areas of the first photoresist layer to produce therein regions with greater solubility and regions of lesser solubility. The regions of greater solubility are subsequently removed to uncover areas of the inner surface of the faceplate panel, while retaining the regions of lesser solubility. The inner surface of the faceplate panel and the retained regions are then overcoated with a light-absorbing material. Thereafter, the retained regions of the first photoresist layer and the light-absorbing material thereon are removed, uncovering portions of the faceplate panel and defining first guardbands of light-absorbing material on the inner surface of the faceplate panel. This photolithographic process is repeated with a second photoresist layer and a third photoresist layer to define second guardbands of light-absorbing material and third guardbands of light-absorbing material, respectively. However, the light source positions for the second photoresist layer and the third photoresist layer are located at asymmetric positions relative to the central source position.

### FIELD OF THE INVENTION

The invention relates to a color cathode-ray tube (CRT) and, more particularly to a color CRT including a luminescent screen assembly.

### BACKGROUND OF THE INVENTION

A color cathode-ray tube (CRT) typically includes an electron gun, an aperture mask, and a screen. The aperture mask is interposed between the electron gun and the screen. The screen is located on an inner surface of a faceplate of the CRT tube. The aperture mask functions to direct electron beams generated in the electron gun toward appropriate color-emitting phosphors on the screen of the CRT tube.

The screen may be a luminescent screen. Luminescent screens typically comprise an array of three different color-emitting phosphors (e.g., green, blue, and red). Each color-emitting phosphor is separated one from the other by a matrix line. The matrix lines are formed of a light-absorbing black inert material.

The matrix lines may be deposited on the screen using aperture mask photolithographic processes, such as those described in U.S. Pat. No. 3,558,310. In aperture mask photolithographic processes, images of the aperture mask are formed in a layer of photoresist material coated on the screen, through exposure to actinic ultraviolet (UV) light and development in an appropriate developer, providing covered areas and uncovered areas on the screen surface. The covered areas on the screen surface are exposed to greater dosages of the actinic UV light, while the uncovered areas on the screen surface are exposed to lesser dosages of the actinic UV light.

For aperture mask lithographic processes, the aperture mask is positioned a fixed distance from the screen such that shadows therefrom, projected onto the resist coated screen during exposure to actinic UV light, uncover matrix line openings in the photoresist having desired dimensions and positioned at appropriate locations on the screen. The covered areas define the matrix line openings, which will be filled with phosphor material. The uncovered areas define the black, light absorbing matrix lines.

The matrix lines are formed by depositing the matrix material on both the covered and uncovered areas of the screen surface. After the matrix material, which typically comprises colloidal graphite, dries, an etchant is applied to solubilize the remaining photoresist that had been exposed to greater dosages of actinic UV light. The matrix line structure is completed by developing with high-pressure water such that the remaining photoresist and the matrix material coating it are released, thereby leaving behind on the surface of the screen only the matrix material that had coated the uncovered areas thereof.

Conventional aperture masks typically have a transmission of about 18% to about 22%. Recently, in order to increase the brightness in a CRT tube without increasing the respective size of the matrix openings, aperture masks having transmissions of about 20% to about 80% have been incorporated into the color CRT tube. However, matrix line formation using aperture masks with transmissions of about 30% to about 80% cannot be achieved utilizing conventional matrix processes such as those described in U.S. Pat. No. 3,558,310, since the light images projected therefrom overlap each other causing the location of such matrix lines to be misaligned on the screen surface as well as have varying dimensions.

Accordingly, a new method of manufacturing the matrix on a luminescent screen is required.

### SUMMARY OF THE INVENTION

The present invention relates to a method of manufacturing a luminescent screen assembly, having a light-absorbing matrix with a plurality of substantially equally-sized openings therein, on an inner surface of a faceplate panel of a cathode-ray tube (CRT). The tube has a color selection electrode or aperture mask spaced from the inner surface of the faceplate panel in which the color selection electrode has a plurality of slots.

The method includes the steps of exposing a first photoresist layer to light from a light source, located relative to a central source position, as well as two symmetrical source positions relative to the central source position. The exposure selectively alters the solubility of the illuminated areas of the first photoresist layer to produce therein regions with greater solubility and regions of lesser solubility. The regions of greater solubility are subsequently removed to uncover areas of the inner surface of the faceplate panel, while retaining the regions of lesser solubility. The inner surface of the faceplate panel and the retained regions are then overcoated with a light-absorbing material. Thereafter, the retained regions of the first photoresist layer and the light-absorbing material thereon are removed, uncovering portions of the faceplate panel and defining first guardbands of light-absorbing material on the inner surface of the faceplate panel. This photolithographic process is repeated with a second photoresist layer and a third photoresist layer to define second guardbands of light-absorbing material and third guardbands of light-absorbing material, respectively. However, the light source positions for the second photoresist layer and the third photoresist layer are located at asymmetric positions relative to the central source position.

The light-absorbing material applied to the interior surface of the faceplate panel preferably includes greater than about 5% by weight of solids. Additionally, an overcoat layer may be applied over the light absorbing material to seal such layer and reduce the porosity thereof.

### BRIEF DESCRIPTION OF THE DRAWINGS

The invention will now be described in greater detail, with relation to the accompanying drawings, in which:

FIG. 1 is a plan view, partly in axial section, of a color cathode-ray tube (CRT) made according to the present invention;

FIG. 2 is a section of a mask and a faceplate panel portion of the CRT of FIG. 1, showing a screen assembly;

FIG. 3 is a plan view of a mask and frame used in the CRT of FIG. 1;

FIGS. 4a-4c are block diagrams comprising flow charts of the RB, GR and GB guardband manufacturing processes for the screen assembly of FIG. 2;

FIGS. 5a-5e depict views of the interior surface of the faceplate panel during RB guardband formation;

FIG. 6 depicts the light source positions used to form the RB guardbands;

FIGS. 7a-7e depict views of the interior surface of the faceplate panel during GR guardband formation;

FIG. 8 depicts the light source positions used to form the GR guardbands;

FIGS. 9a-9e depict views of the interior surface of the faceplate panel during GB guardband formation;

FIG. 10 depicts the light source positions used to form the GB guardbands; and

FIGS. 11a-11c illustrate different orientations of the faceplate panel at the onset of deposition of the photoresist and/or the light-absorbing material.

### DETAILED DESCRIPTION OF THE PREFERRED EMBODIMENT

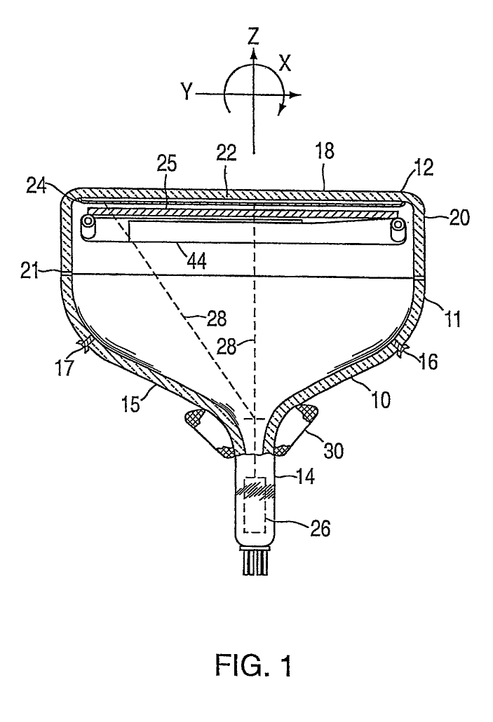

FIG. 1 shows a color cathode-ray tube (CRT) 10 having a glass envelope 11 comprising a faceplate panel 12 and a tubular neck 14 connected by a funnel 15. The funnel 15 has an internal conductive coating (not shown) that is in contact with, and extends from, an anode button 16 to the neck 14.

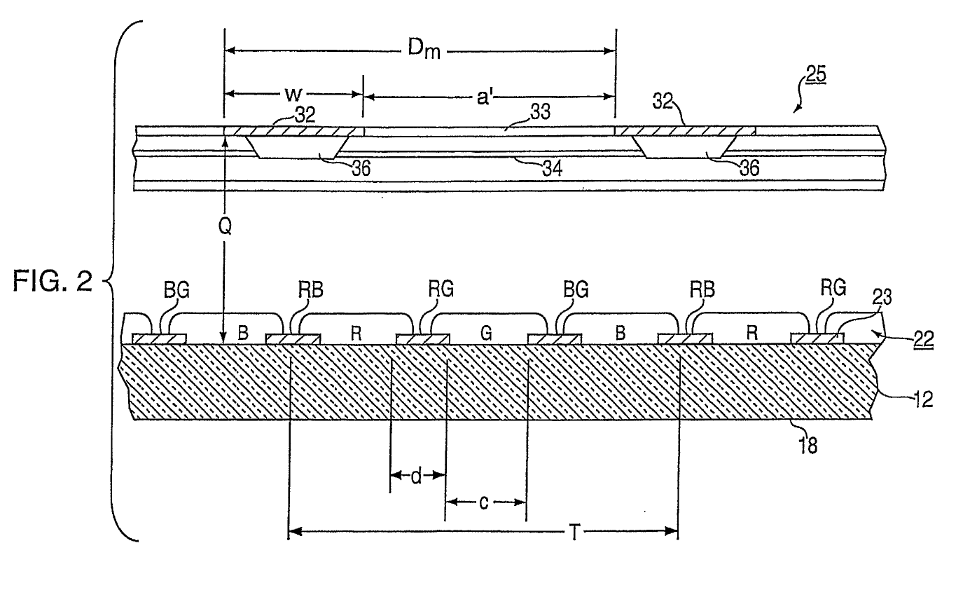

The faceplate panel 12 comprises a viewing faceplate 18 and a peripheral flange or sidewall 20 that is sealed to the funnel 15 by a glass frit 21. A three-color luminescent phosphor screen 22 is carried on the inner surface of the viewing faceplate 18. The screen 22, shown in cross-section in FIG. 2, is a line screen which includes a multiplicity of screen elements comprising red-emitting, green-emitting, and blue-emitting phosphor stripes R, G, and B, respectively, arranged in triads, each triad including a phosphor line of each of the three colors. The R, G, B, phosphor stripes are generally printed with a vertical orientation.

A light absorbing matrix 23, shown in FIG. 2, separates the phosphor lines. A thin conductive layer (not shown), preferably of aluminum, overlies the screen 22 and provides means for applying a uniform first anode potential to the screen 22, as well as for reflecting light, emitted from the phosphor elements, through the faceplate 18. The screen 22 and the overlying aluminum layer comprise a screen assembly.

A multi-aperture color selection electrode, or mask 25, is removably mounted, by conventional means, within the faceplate panel 12, in predetermined spaced relation to the screen 22. This space relation or distance of the mask 25 from the faceplate panel 12 is referred to as the “Q” spacing.

An electron gun 26, shown schematically by the dashed lines in FIG. 1, is centrally mounted within the neck 14, to generate and direct three inline electron beams 28, a center and two side or outer beams, along convergent paths through the mask 25 to the screen 22. The inline direction of the center beam 28 is approximately normal to the plane of the paper.

The CRT 10 of FIG. 1 is designed to be used with an external magnetic deflection yoke 30, in the neighborhood of the funnel-to-neck junction. When activated, the yoke 30 subjects the three electron beams 28 to magnetic fields that cause the electron beams 28 to scan a horizontal and vertical rectangular raster across the screen 22.

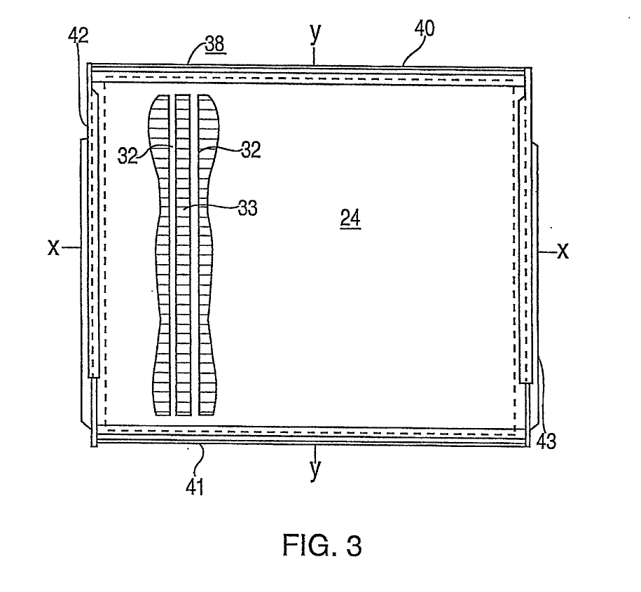

As shown in FIG. 3, the mask 25 is formed, preferably, from a thin rectangular sheet of about 0.05 mm (2 mil) thick low carbon steel, that includes two horizontal sides and two vertical sides. The two horizontal sides of the mask 25 parallel the central major axis, X, of the mask and the two vertical sides parallel the central minor axis, Y, of the mask. With reference to FIGS. 2 and 3, the mask 25 includes an apertured portion that contains a plurality of elongated strands 32 separated by slots 33 that parallel the minor axis, Y, of the mask.

In one configuration, the mask pitch, Dₘ, defined as the transverse dimension of a strand 32 and an adjacent slot 33, is 0.87 mm (37 mils). As shown in FIG. 2, each strand 32 can have a transverse dimension, or width, w, of about 0.38 mm (15 mils) and each slot 33 can have a width, a′, of about 0.53 mm (21 mils). The slots 33 extend from one horizontal side of the mask to the other horizontal side thereof. The pitch, Dₘ of the mask 25 can be varied. For example, in a second configuration, with a mask pitch of about 0.68 mm (27 mils) and a strand width of about 0.3 mm (12 mils), each matrix opening has a width, c, of about 0.13 mm (5 mils). Again with reference to FIG. 2, the screen 22, formed on the viewing faceplate 18, includes the light-absorbing matrix 23 with rectangular openings in which the color-emitting phosphor lines are disposed. The corresponding matrix openings have a width, c, of about 0.20 mm (8 mils). The width, d, of each matrix line is about 0.10 mm (4 mils) and each phosphor triad has a width or screen pitch, T, of about 0.96 mm (38 mils). For this embodiment, the mask 25 is spaced at a distance, Q, (hereinafter Q-spacing) of about 15.24 mm (600 mils) from the center of the interior surface of the faceplate panel 12.

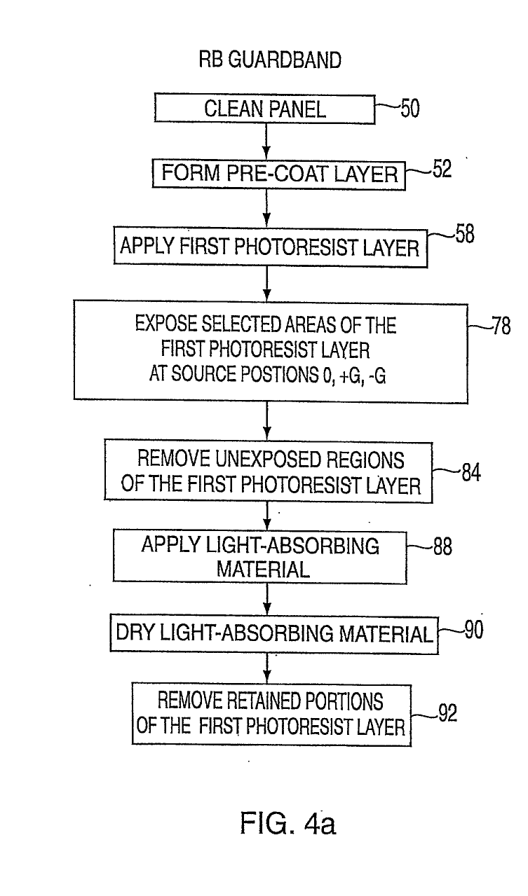

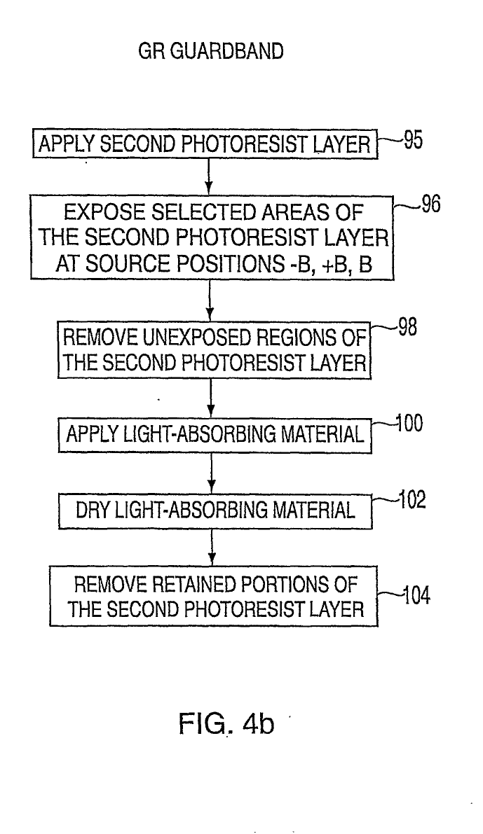

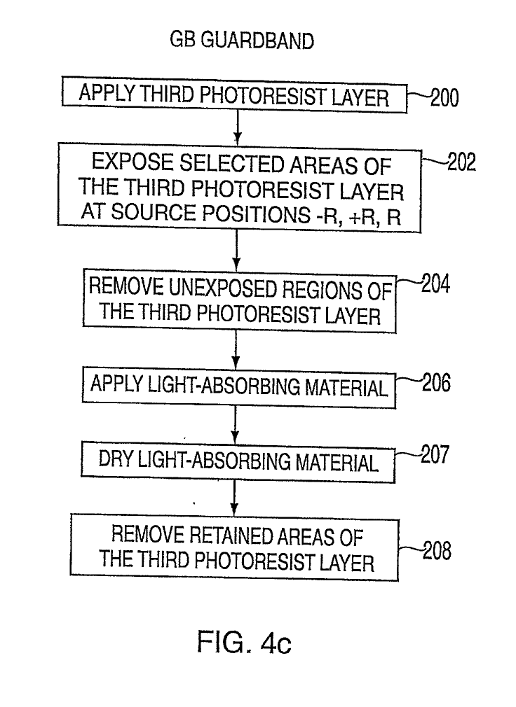

The process for manufacturing the light-absorbing matrix according to the preferred embodiment begins with cleaning the interior surface of the faceplate 18 with an acid such as hydrofluoric acid (HF). The cleaning process, indicated as panel cleaning step 50 in FIG. 4a, is concluded by rinsing the faceplate 18 with copious quantities of water.

A polymer precoat layer (not shown) may be applied to the interior surface of the faceplate 18, as indicated by step 52 in FIG. 4a. The polymer precoat layer is a thin film that enhances the adhesion of the light absorbing material and promotes greater opacity of the matrix lines. The polymer precoat layer may comprise a material such as polyvinyl alcohol (PVA). The polymer precoat layer may be deposited by spin coating a 0.1 to 0.3% aqueous PVA solution thereon. The polymer precoat layer typically has a thickness no greater than about 0.25 μm.

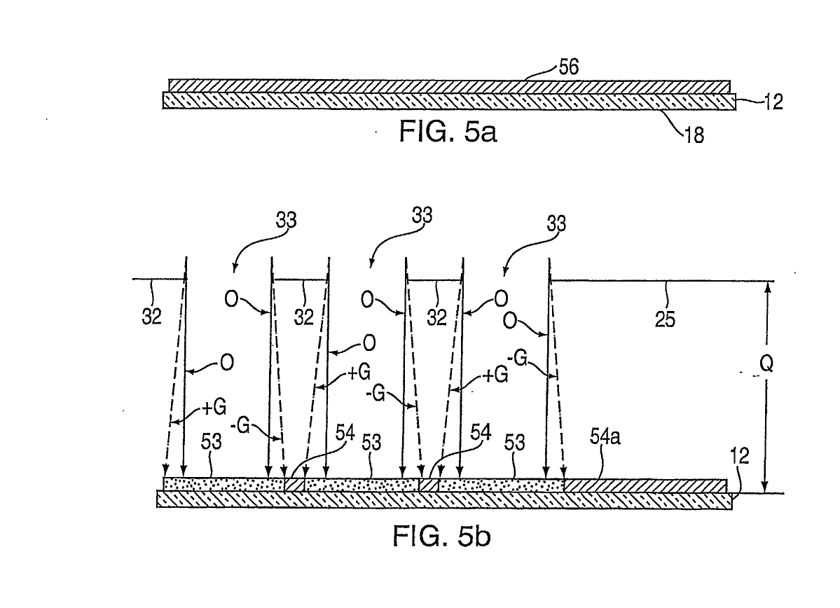

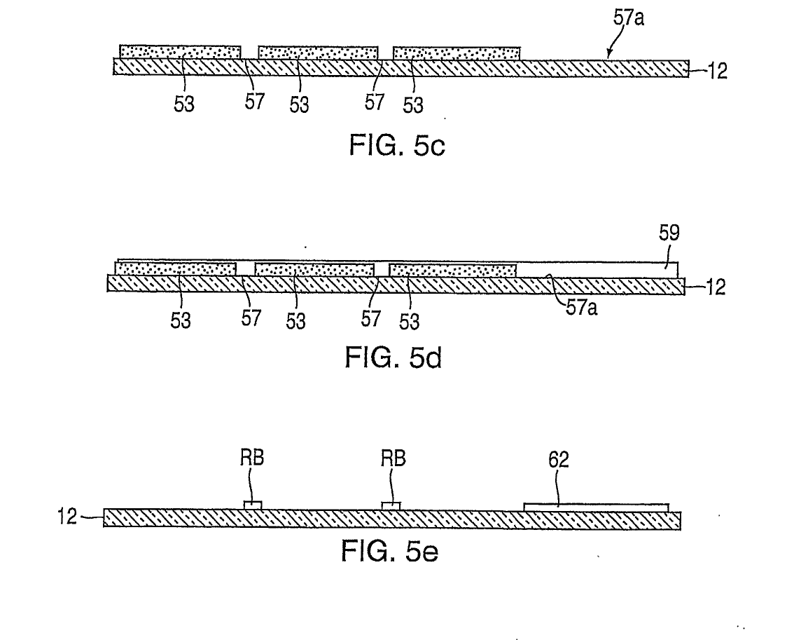

Referring to FIG. 5a and step 58 of FIG. 4a, a first photoresist layer 56 is applied, by spin coating, on the inner surface of the viewing faceplate 18. The first photoresist layer 56 may comprise a polyvinyl pyrrolidone (PVP)-diazido stilbene system, a polyvinyl alcohol (PVA)-dichromate system, or other suitable negative photoresist systems.

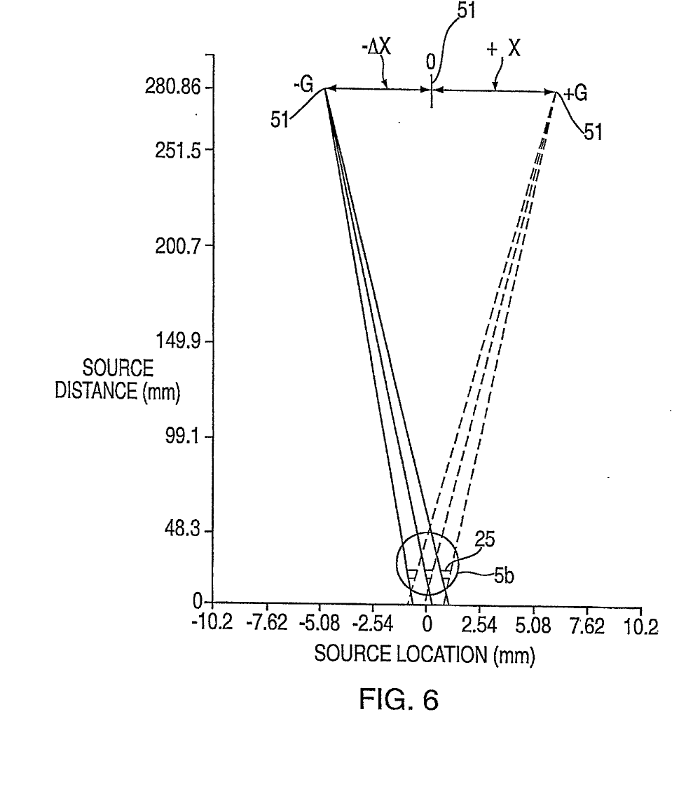

As shown in FIG. 5b, a mask 25 is secured near the faceplate panel 12 and the panel-mask assembly placed on a lighthouse (not shown). The mask 25 is positioned between the faceplate panel 12 and a movable light source 51, shown in FIG. 6. The first photoresist layer 56 is exposed to light, through the slots 33 of the mask 25, from the RB source positions (green source positions), as indicated by step 78 in FIG. 4a. The first color source position, +G, is located at a distance, ΔX, relative to a central source position or standard green location, 0. The second color source position, −G, is located a distance, −ΔX, relative to the central source position, 0. For a 68 cm mask, ΔX can be about 1.78 mm (70 mils). The third source position is preferably the central source position, 0. However, this third source position can be from at least one position between −ΔX and ΔX The third source position ensures that regions 53 of the first photoresist layer 56 are entirely exposed thereby producing a desired level of lesser solubility therein.

The Q-spacing between the mask 25 and the interior surface of the faceplate panel 12, on which the first photoresist layer 56 is disposed is about 449 mils. The light emanating from the three source positions selectively alters the solubility of the illuminated areas of the first photoresist layer 56 thereby producing regions 53 of lesser solubility. The areas 54 and 54a of the first photoresist layer 56 that are shaded by the mask strands. Areas 54 and 54a are unchanged and constitute areas of greater solubility. The areas 54 define the matrix RB guardband where +G defines the red edge of guardband RB and −G defines the blue edge of guardband RB. Area 54a defines where the phosphor screen terminates.

As shown in FIG. 5c and indicated by step 84 in FIG. 4a, the first photoresist layer 56 is developed by rinsing the panel 12 with a suitable solvent, such as for example water. This development step removes the regions 54 and 54a of greater solubility, thereby exposing areas 57 of the surface of the panel 12, while leaving intact the illuminated areas 53 of layer 56 having lesser solubility.

The matrix is formed, as shown in FIG. 5d and indicated in step 88 of FIG. 4a, by overcoating the exposed areas 57 of the surface of the panel 12 as well as the retained areas 53 of layer 56, having lesser solubility, with a first layer of light absorbing material 59. The first layer of the light absorbing material 59 adheres to the interior surface of the faceplate panel 12 in the uncovered areas 57 and 57a. The first layer of the light-absorbing material 59 is preferably made of a suitable graphite composition such as those commercially available from Acheson Colloids Company, Port Huron, Mich.

The first layer of the light-absorbing material 59 preferably comprises a suspension of sub-micron graphite colloids. Additionally, the first layer of light-absorbing material may also include surface-active agents. It is believed that the surface-active agents in the light-absorbing material layer promotes improved wetting of the faceplate panel 12 for film-formation thereon.

The graphite colloids in the suspension are optionally coated with an oxidation barrier. Suitable oxidation barriers may comprise oxides such as, for example, silicon dioxide (SiO₂), and aluminum oxide (Al₂O₃). The oxidation barrier is believed to reduce the oxidation of the graphite during subsequent tube processing.

A composition containing the light-absorbing material with a solids concentration between about 5.5% and about 8.0% is applied to the uncovered areas 57 and 57a, as well as the retained areas 53 of lesser solubility. As indicated by step 90 of FIG. 4a, the first layer of light-absorbing material is dried at temperatures within a range of about 40° C. to about 70° C. for a time period of about 3 minutes to about 5 minutes. The thickness of the first layer of light absorbing material is about 1 μm.

Referring to FIG. 5e and step 92 of FIG. 4a, the light-absorbing matrix is developed by depositing a suitable solvent, such as aqueous periodic acid, or the equivalent, onto the matrix to soften and swell the underlying retained areas 53 of layer 56 having lesser solubility. The matrix is then flushed with water to remove the loosened, less soluble, retained areas 53 of layer 56, forming openings therein, but leaving the RB guardbands and a border 62 of light-absorbing material attached to the exposed portions of the interior surface of the faceplate panel 12.

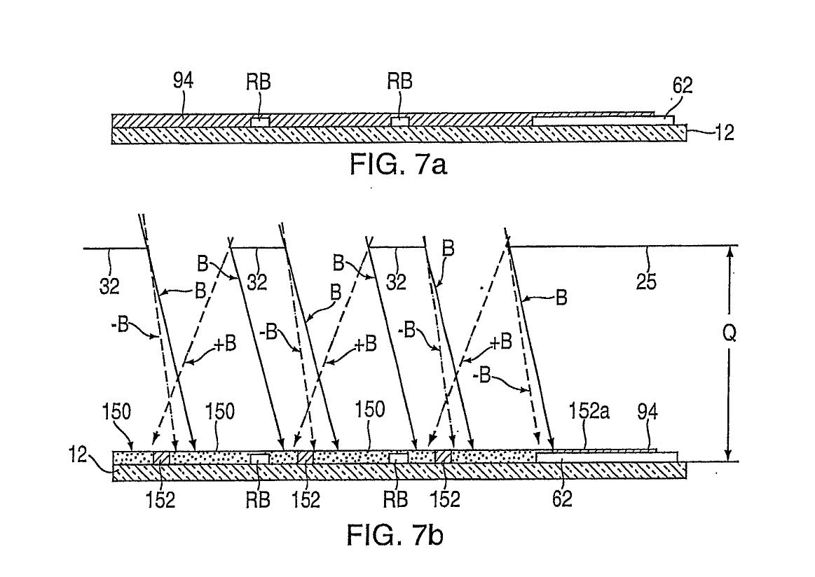

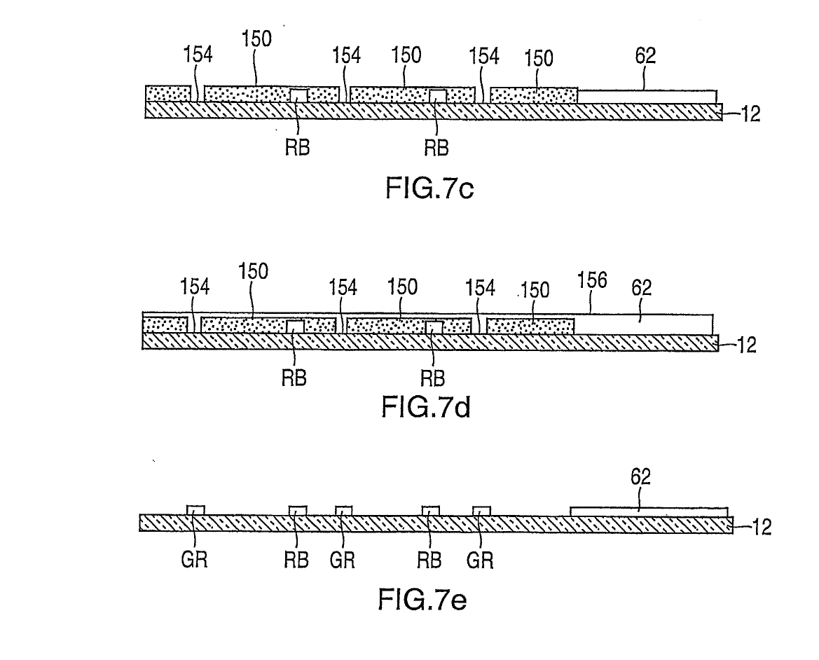

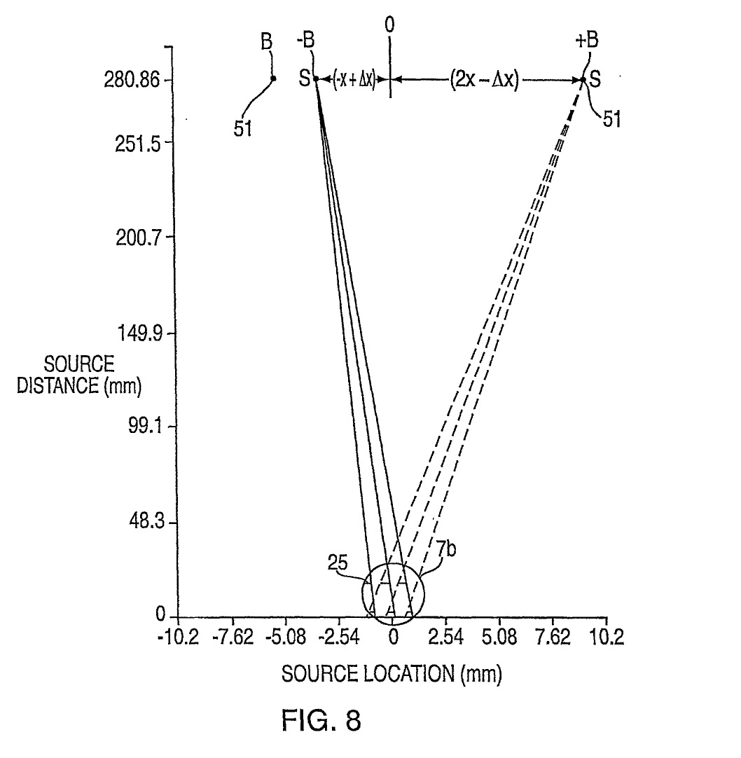

The above-described process is repeated two more times for the GR source positions (blue source positions) and GB source positions (red source positions). As such, a second photoresist layer 94 is applied on the interior surface of the faceplate panel 12, as shown in FIG. 7a and indicated in step 95 of FIG. 4b. Referring to FIGS. 7b and 8 as well as step 96 of FIG. 4b, the second photoresist layer 94 is exposed to light, through the mask 25, from the GR source positions 51, within a lighthouse (not shown). For the GR source positions formed with the 68 cm mask, the color first source position, +B, is asymmetrically located a distance, 2X+ΔX, about 8.99 mm (354 mils) relative to the central source position, 0. The position −X and 2X are known as the primary and secondary source positions for blue, respectively. The second color source position, −B, is asymmetrically located a distance, −X+ΔX, about −3.61 mm (−142 mils), relative to a central source position, 0. The third position is the primary source position for blue, −X, −212 mils (or otherwise known as the standard blue position used in printing blue phosphors lines in a screening process and printing the blue matrix opening in a conventional matrix process. However, this third source position can be from at least one position between −X−ΔX and −X+ΔX.

As shown in FIG. 7b, the Q-spacing between the mask 25 and the inner surface of the faceplate panel 12 is about 449 mils. The light emanating from the GR source positions selectively alters the solubility of the illuminate areas of the second photoresist layer 94, thereby producing regions 150 of lesser solubility. The areas of the second photoresist layer 94 that are shaded by the mask strands 32 are unchanged and constitute regions 152 and 152a of greater solubility. (Start Here) Referring to FIG. 7c and step 98 of FIG. 4b, the photoresist is developed with water, removing regions 152 of greater solubility and uncovering areas 154 of the inner surface of the faceplate panel 12. Regions 150 of the second photoresist layer 94 with lesser solubility are retained.

The matrix is formed, as shown in FIG. 7d and indicated in step 100 of FIG. 4b, by overcoating the uncovered areas 154 and the retained regions 150 of lesser solubility on the inner surface of the faceplate panel 12 with a second layer of light-absorbing material 156. The second layer of light-absorbing material 156 preferably has a similar composition, thickness, etc, as the first layer of light-absorbing material 59 and may be applied using a similar process.

The second layer of the light-absorbing material 156 is dried, as indicated in step 102 of FIG. 4b, and retained regions 150 of the second photoresist layer 94 as well as the second layer of light-absorbing material 156 thereon, are removed. As shown in FIG. 7e and indicated by step 104 of FIG. 4b, the retained regions 150 of the second photoresist layer 94 are removed by rinsing the faceplate panel 12 using a suitable solvent, such as aqueous periodic acid, or the equivalent. After the retained regions 150 of the second photoresist layer 94 are removed GR guardbands, the previously formed RB guardbands, and a border 62 are retained on the inner surface of the faceplate panel 12.

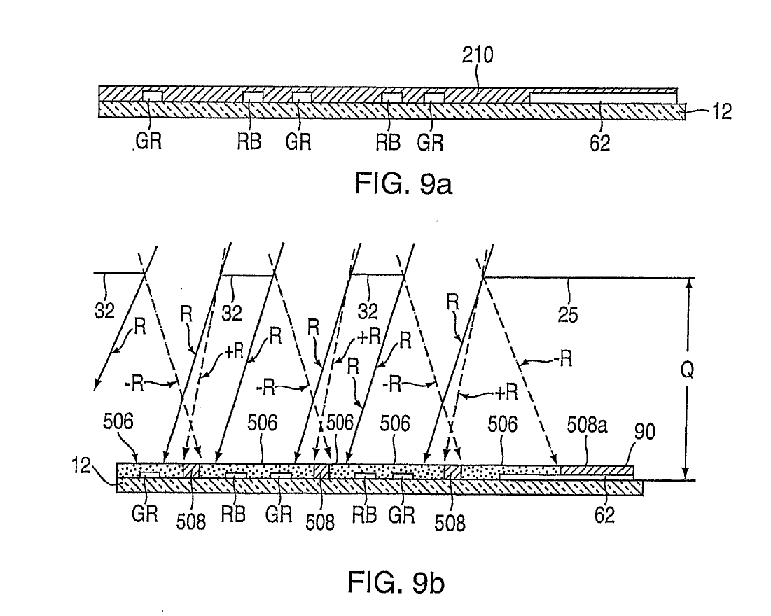

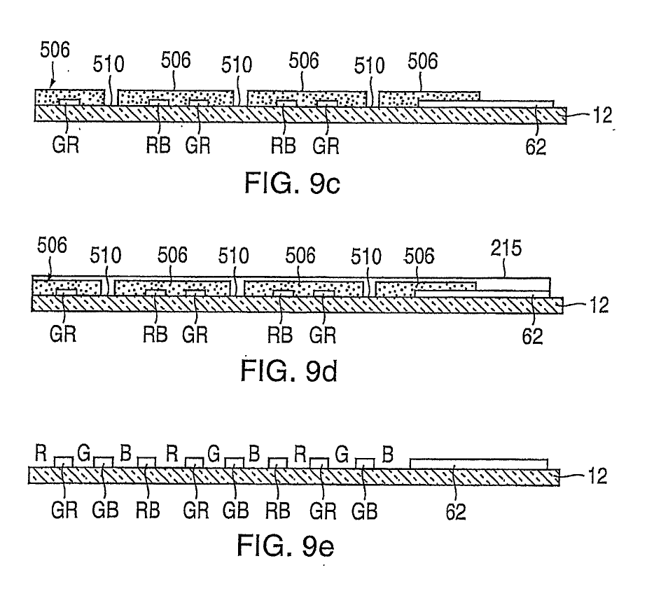

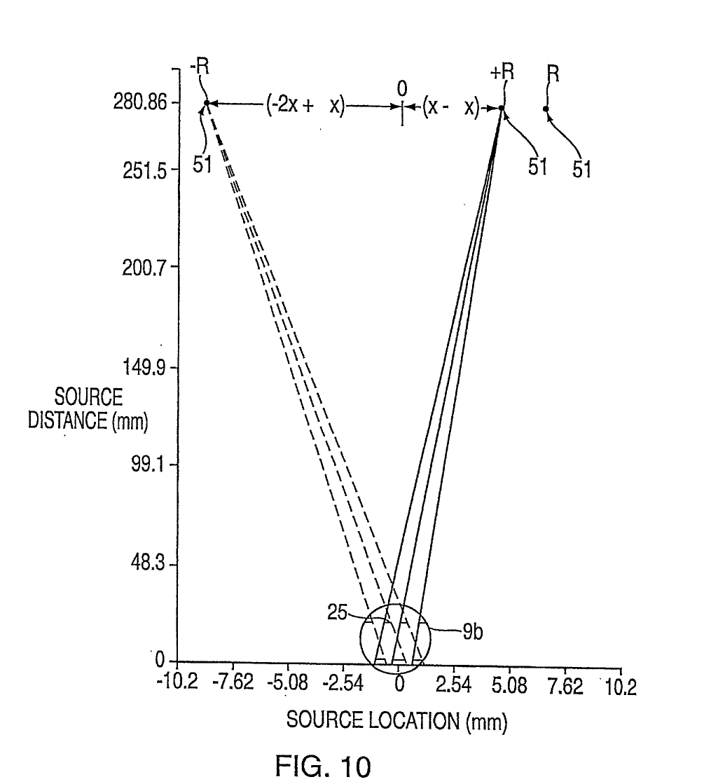

The process is repeated for a third time when a third layer of photoresist material 210 is provided on the inner surface of the faceplate panel 12, as shown in FIG. 9a and indicated in step 200 of FIG. 4c. Referring to FIGS. 9b and 10 as well as step 202 of FIG. 4c, the third photoresist layer 210 is exposed to light, through the mask 25, from the GB source positions, within a lighthouse (not shown). For the GB source positions formed using the 68 cm mask, the first color source position, +R, is asymmetrically located a distance, X−ΔX, about 3.61 mm (142 mils) relative to the central source position, 0. The second color source position, −R, is asymmetrically located a distance, −2X+ΔX, about −8.99 mm (−354 mils), relative to a central source position, 0. The position X and −2X is also known as the primary and secondary source positions for red, respectively. The third source position is the primary source position red, X, 212 mils (or otherwise known as the standard red position used in printing blue phosphors lines in a screening process and printing the blue matrix opening in a conventional matrix process). However, this third source position can be from at least one position between X−ΔX and X+ΔX.

As shown in FIG. 9b, the Q-spacing between the mask 25 and the inner surface of the faceplate panel 12, on which the third photoresist layer 210 is disposed, remains at about 449 mils. The light emanating from the GB source positions selectively alters the solubility of the illuminated areas of the third photoresist layer 210, thereby producing regions 506 of lesser solubility. The areas of the third photoresist layer 210 that are shaded by the mask strands 32 are unchanged and constitute regions 508 and 508a of greater solubility.

Referring to FIG. 9c and step 204 of FIG. 4c, the third photoresist layer 210 is developed with water, thereby removing the regions of greater solubility 508 and 508a, thereby uncovering areas 510 of the inner surface of the faceplate panel 12. Regions 506 of the third photoresist layer 210 with lesser solubility are retained.

The matrix is formed, as shown in FIG. 9d and indicated in step 206 of FIG. 4c, by overcoating uncovered areas 510 as well as retained regions 506 of the third photoresist layer 210 on the faceplate panel 12 with a third layer of light-absorbing material 215. The third layer of light-absorbing material 215 preferably has a similar composition, thickness, etc, as the first layer of light-absorbing material 59 and second layer of light-absorbing material 156.

The third layer of light-absorbing material is dried, as indicated in step 207 of FIG. 4c, and the retained regions 506 of the third photoresist layer 210 as well as the light-absorbing material 206 thereon, are removed. As shown in FIG. 9e and indicated in step 208 of FIG. 4c, the retained regions 506 of the third photoresist layer 210 are removed by rinsing the faceplate panel 12 using a suitable solvent, such as aqueous periodic acid, or the equivalent. After the retained regions 506 of the third photoresist layer 210 are removed GB guardbands, the previously formed GR and RB guardbands, and the border 62 are retained on the inner surface of the faceplate panel 12.

After forming the series of three guardbands, a potassium silicate coating (not shown) may be disposed atop the matrix. Prior to the application of the silicate, deionized water is applied to the first guardbands RB, second guardbands GB, and third guardbands GR, as well as the areas between the guardbands. These areas are otherwise known as matrix openings. The deionized water is preferably held a temperature of about 40° C. Excess deionized water is then spun off, and the potassium silicate solution, also at about 40° C., is applied. Preferably, the potassium silicate solution has a concentration of about 3.5% by weight in deionized water. Excess potassium silicate is spun off at a rate of about 130 rpm for a time period of about 30 seconds. The potassium silicate film is then dried at a temperature of about 40° C. to about 60° C. for a time period of about 5 minutes. Suitable potassium silicate compositions are commercially available such as KASIL® brand, available from the PQ Corporation, Valley Forge, Pa. The potassium silicate coating preferably has a thickness of about 0.5 μm to about 1.0 μm. The presence of the potassium silicate coating on the guardbands and the matrix openings prevents the deterioration of the guardbands during subsequent processing.

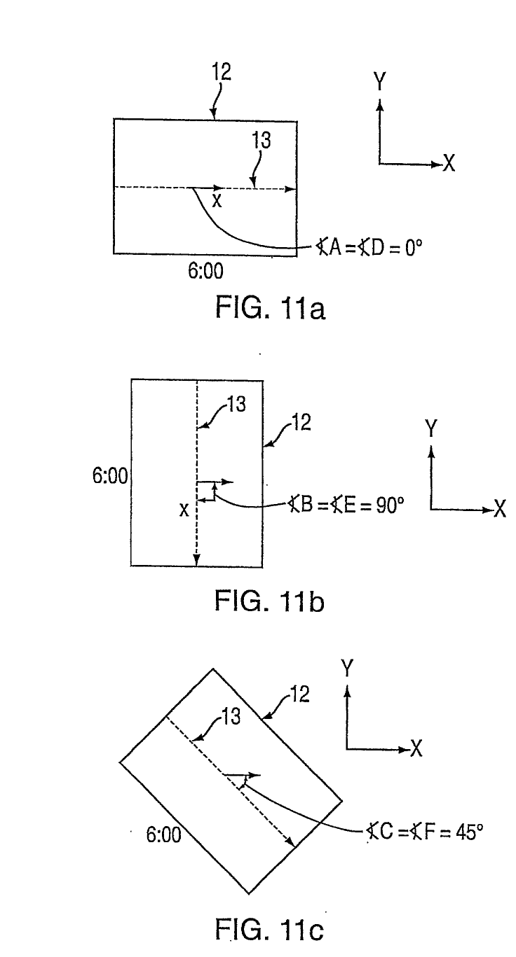

Further improvements to the matrix process described in U.S. Pat. No. 6,013,400 are realized by intentionally altering the techniques used to apply the three photoresist layers. Specifically, the first photoresist layer 56, the second photoresist layer 94, and the third photoresist layer 210 may be applied using different orientations, <A, <B, and <C, with respect to each other. For example, FIGS. 11a-11c, illustrate different orientations of the faceplate panel 12 at the onset of photoresist layer formation, wherein the major axis 13 of the faceplate panel 12 is oriented relative to the fixed X-axis of the spin coat machine.

Alternatively, the first layer of light-absorbing material 59, the second layer of light-absorbing material 156, and the third layer of light-absorbing material 215 may also be applied using different orientations, <D, <E, and <F, with respect to each other. For example, FIGS. 11a-11c, may also illustrate different orientations of the faceplate panel at the onset of light-absorbing material application, wherein the major axis 13 of the faceplate panel 12 is oriented relative to the fixed X-axis of the spin coat machine.

Additionally, the first photoresist layer 56, the second photoresist layer 94, and the third photoresist layer 210 may also be applied on the faceplate panel 12 using different spin rates, A′, B′, and C′. Spin rates such as, for example, 90 rpm, 110 rpm, and 130 rpm, may be used for A′, B′, and C′, respectively. Similarly, the first light-absorbing material 59, the second light-absorbing material 156, and the third first light-absorbing material 215 may be applied on the faceplate panel 12 using different spin rates, D′, E′, and F′. Again, spin rates such as, for example, 90 rpm, 110 rpm, and 130 rpm, may also be used for D′, E′, F′.

Modulating the orientation and/or spin rates of the photoresist layers and/or the light-absorbing materials, creates multiple streak patterns in the light-absorbing material that are mismatched with respect to one another. The result is the human eye has difficulty resolving any net streak pattern in the finished CRT faceplate panel. This “optical confusion” generated using the techniques described above reduces or eliminates the perception of unappealing patterns on the display screen.

The exposure sequence of the current invention also represents an improvement over U.S. Pat. No. 6,013,400 in that, the third exposure (i.e., the central source position, 0 for guardband RB, B in guardband GR, and R in guardband GB) in the deposition sequence for each guardband is novel. The third exposure is novel in that this exposure prevents anomalous or extra guardbands from being printed, particularly at lower mask transmissions.

For example, at mask transmission values of about 45% or less, anomalous guardbands may be printed. Referring to FIGS. 5b, 7b, and 9c, at lower mask transmissions, for any given guardband printing sequence, it is possible that there is not sufficient overlap between the first exposure (i.e., −G, −B and −R) and the second exposure (i.e., +G, +B, and +R) to harden the photoresist in the central areas between the guardbands (i.e., region 53, region 150, and region 506). The result is that anomalous guardbands may be formed in these central areas, rendering the display screen non-functional. However, referring to FIGS. 6, 8, and 10, the incorporation of the third exposure (i.e., 0, B, and R) provides sufficient exposure to harden the photoresist in all areas except in the location of the intended guardbands RG, GR, and GB, shown in FIGS. 5e, 7e and 9e, respectively.

What is claimed is:

1. A method of manufacturing a light absorbing matrix, having a plurality of substantially equally sized openings therein, on an inner surface of a faceplate panel of a CRT having a color selection electrode spaced from the inner surface of the faceplate panel with the color selection electrode having a plurality of slots, comprising the steps of:
(a) exposing a first photoresist layer formed on the interior surface of the faceplate panel to light through the slots in the color selection electrode, wherein the ultraviolet light is generated from three source locations including two outer positions and an inner position, wherein the two outer source positions are symmetrically located about the inner source position, and wherein the inner source position is a central source position;
(b) removing unexposed portions of the first photoresist layer;
(c) overcoating the interior surface of the faceplate panel with a light-absorbing matrix material;
(d) removing retained portions of the first photoresist layer to form first guardbands of light-absorbing material on the inner surface of the faceplate panel; and,
(e) repeating steps (a) through (d) twice more to form second and third guardbands of light-absorbing material, using second and third photoresist layers, respectively, wherein the three source positions for each of the second and third exposure steps are asymmetrically located with respect to the central source position.

2. The method of claim 1, further comprising the step of applying a protective coating on the light-absorbing matrix after formation of the third guardbands on the surface of the faceplate panel.

3. The method of claim 2 wherein the protective coating comprises potassium silicate.

4. The method of claim 1 wherein the light-absorbing matrix material comprises graphite.

5. The method of claim 4 wherein the graphite comprises an oxidation barrier.

6. The method of claim 5 wherein the oxidation barrier is selected from the group consisting of silicon oxide (SiO₂) and aluminum oxide (Al₂O₃).

7. The method of claim 1 wherein step (c) further comprises heating the light-absorbing material overcoated on the surface of the faceplate panel to a temperature within a range of about 40° C. to about 60° C.

8. The method of claim 1 wherein the light-absorbing material overcoated on the surface of the faceplate panel has a solids content within a range of about 5% by weight to about 8% by weight.

9. The method of claim 1 wherein the second and third photoresist layers are applied at different spin speeds from each other as well as from the first photoresist layer.

10. The method of claim 1 wherein the second and third light-absorbing material layers are applied at different spin speeds from each other as well as from the first light-absorbing material layer.

11. The method of claim 1 wherein the first, second and third photoresist layers are applied on the faceplate panel using different orientations for the faceplate panel with respect to a fixed axis.

12. The method of claim 1 wherein the first, second and third light-absorbing material layers are applied on the faceplate panel using different orientations for the faceplate panel with respect to a fixed axis.

13. A method of manufacturing a light absorbing matrix, having a plurality of substantially equally sized openings therein, on an inner surface of a faceplate panel of a CRT having a color selection electrode spaced from the inner surface of the faceplate panel the color selection electrode having a plurality of slots, comprising the steps of:
a) applying a first photoresist layer on the interior surface of the faceplate panel whose solubility is altered when it is exposed to light;
b) exposing the first photoresist layer to light through the slots in the color selection electrode from at least three source positions including a central primary source position aligned with a color source and two symmetrically displaced positions, −ΔX and +ΔX, relative to the central primary source position;
c) removing unexposed portions of the first photoresist layer;
d) overcoating the interior surface of the faceplate panel with a light-absorbing matrix material;
e) removing retained portions of the first photoresist layer to form first guardbands of light-absorbing material on the inner surface of the faceplate panel; and
f) repeating steps (a) through (e) twice more to form a second and third guardbands of light-absorbing material, using a second and third photoresist layers, respectively, wherein:
i) three source positions for printing the second guardband include exposures from the following source positions: a position displaced from a primary source position by AX toward the central primary source position, a position displaced from a secondary source position by ΔX toward the central primary source position, and the primary source position; and
ii) three source positions for printing the third guardband include exposures from the following source positions: a position displaced from another primary source position by AX toward the central primary source position, a position displaced from another secondary source position by ΔX toward the central primary source position, and the another primary source position.

14. A method of claim 13 wherein the second guardband is printed before the first guardband.

15. A method of claim 13 wherein the third guardband is printed before the first guardband.

16. A method of claim 13 wherein the exposure from the central primary source position is replaced by an exposure from at least one source position that is within ΔX/2 of the central primary source position.

17. A method of claim 13 wherein the exposure from the primary source position is replaced by an exposure from at least one source position that is within ΔX/2 of the primary source position.

18. A method of claim 13 wherein the exposure from the another primary source position is replace by an exposure from at least one source position that is within ΔX/2 of the another primary source position.

19. A method of forming a light absorbing matrix including exposing to light and selectively hardening photoresist material layers on the inner surface of the faceplate panel of a CRT to form the matrix in which the selective exposure comprise the steps of:
a) projecting at least three light sources for a first exposure onto the photoresist material layer through a slot of a mask located between the light sources and the inner surface of the faceplate panel wherein one of the light sources is aligned with a first color source position, G, along a central source position, 0, and the remaining light sources are positioned from at least two symmetrically displaced positions, −ΔX and ΔX, on either side of the central color source position;
b) projecting the light sources for a second exposure onto a second photoresist material layer through the slot of the mask wherein at least one of the light sources is aligned with an alternative color source position, B, a distance, −X, from the central source position and two light sources are positioned at two positions, −X+ΔX and 2X−ΔX, from the central source position; and,
c) projecting the light sources for a third exposure onto a third photoresist material layer through the slot of the mask wherein at least one of the light sources is aligned with an alternative color source position, R, a distance, X, from the central source position and two light sources are positioned at two positions, X−ΔX and −2X+ΔX, from the central source position.
